(19) United States
(12) Patent Application Publication
(10) Pub. No.: US 2021/0088091 A1
(43) Pub. Date: Mar. 25, 2021

(54) BRAKE STROKE INDICATOR ATTACHMENT

(71) Applicants: Charlie Arsenault, Rexton (CA); Kevin Falconer, Cambridge (CA)

(72) Inventor: Kevin Falconer, Cambridge (CA)

(73) Assignees: Charlie Arsenault, Rexton, NB (CA); Kevin Falconer, Cambridge, ON (CA)

(21) Appl. No.: 16/576,538

(22) Filed: Sep. 19, 2019

(51) Int. Cl. F16D 65/02; F16D 65/44; B60T 7/04

(52) U.S. Cl. CPC F16D 65/02; F16D 65/44; B60T 2220/04; F16D 2250/0084; F16D 2250/0061; B60T 7/042

(57) ABSTRACT

The present disclosure provides a brake stroke indicator attachment for use with a sensor further comprised of a first bracket secured to the vehicle, the first bracket adjustably secured to the second bracket with securing mechanism to adjust a length of the attachment relative to the vehicle's slack adjuster. The second bracket is further comprised of an opening to receive the brake wear sensor, the brake wear sensor to be activated based on wear and tear of the brake pads.

### FIELD

The disclosure relates to the field of braking systems, and more specifically to brake stroke indicator attachments.

### BACKGROUND

Knowing and checking a vehicle's brake stroke is crucial in the trucking industry, as when the brake stroke is too long, the brakes likely need repair or replacement. There are various types of indicators exist to monitor such brake strokes. The most predominant indicators consist of a simple bracket attached to the brake chamber stud with two pins pointing down. A pin pointing outwardly is attached to the pushrod of the maxi; said pin having to be between the two pins pointing down. The issues with this system are that the pins are not always visible, they bend and become loose and move, and the driver has to get on his/her knees to see the pins.

There are also a few light indicator systems for pneumatic brake systems, but they have issues as well. For example, if the brakes on such a system are not properly adjusted, a light is triggered to come on to alert the operator before the equipment is not road worthy.

Prior adjustment indicators have been devised to address the aforementioned problems. For example, U.S. Pat. No. 4,279,214 discloses a brake adjustment indicator that can be installed on a vehicle with pneumatic brakes. The indicator includes a sleeve that loosely fits over the push rod of a pneumatic actuator. Meanwhile, U.S. Pat. No. 4,776,438, discloses a brake adjustment indicator that includes a mounting bracket having an elongated body with a slot that runs parallel to a rod that extends through an air brake chamber and connects at one end to the brake arm by a clevis pin. U.S. Pat. No. 4,879,964 discloses an air brake adjustment marker that includes an air supply, an air canister, and moveable members that include a push rod that extends from the air canister and has a first extended position and a second over-extended position. The adjustment marker includes a chain attached to the push rod, and an indicator flag that is activated when the push rod is in the overextended position. U.S. Pat. No. 5,244,061 discloses an air brake stroke length gage that operates in conjunction with an air brake system. The gauge comprises of a stroke length indicator that is mounted on the push rod, and a reference marker that is attached to the air brake system at a distance that corresponds to the appropriate stroke length for the brake system when properly adjusted. U.S. Pat. No. 5,320,198 discloses an indicator for indicating the setting and linear stroke movement of a brake rod of a brake assembly. The gauge includes reference indicators that are located on both the brake rod's clevis and on the arm of the brake's slack adjustment member, thereby indicating the brake rod travel and the need for brake adjustment. U.S. Pat. No. 5,441,128 discloses a bracket body that can be attached to a brake rod and to the clevis member of a conventional brake adjustment apparatus. The bracket body provides for an indirect measurement of the brake rod travel and adjustment. U.S. Pat. No. 8,078,375 discloses a sensor that measures the axis of the cam shaft travel. The sensor is mounted too the cam shaft for rotational measuring. Canadian patent application 2,186,271 shows the use of a brake adjustment indicator including a mounting bracket, having an elongated body with a slot, and a spacer for receiving two bolts for indicating limit positions.

There is a need to fix some of the aforementioned issues that have been not resolved by the prior art. Indeed, there is a need for a system that does not require driver to bend down, is more reliable and can work for any size brake chamber and the travel distance allowed by such chamber.

### SUMMARY

In an aspect, the present disclosure provides a brake stroke indicator attachment for use with brakes comprising: a first bracket secured to a vehicle, the first bracket further comprised of at least a first aperture; and, a second bracket secured to the first bracket, the second bracket further comprised of: an elongated portion further comprised of a second aperture; and, a stepped portion further comprised of an opening, wherein the opening of the second bracket is constructed and arranged to receive and secure a sensor thereto.

In another aspect, the present disclosure provides a method of installation of a brake stroke indicator attachment for use with brakes, the steps comprising: securing a first bracket to a brake chamber stud; and, adjusting a second bracket relative to the first bracket to a distance X from the slack adjuster, wherein X is defined as ¾ of a brake stroke travel limit.

### BRIEF DESCRIPTION OF THE DRAWINGS

The following figures serve to illustrate various embodiments of features of the disclosure. These figures are illustrative and are not intended to be limiting.

FIG. 1 is a perspective view of a brake stroke indicator attachment, according to an embodiment of the present disclosure;

FIG. 2 is a front view of a first bracket for a brake stroke indicator attachment, according to an embodiment of the present disclosure;

FIG. 3 is a front view of a second bracket for a brake stroke indicator attachment, according to an embodiment of the present disclosure; and,

FIG. 4 is a perspective view of a brake stroke indicator attachment secured to a vehicle, according to an embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

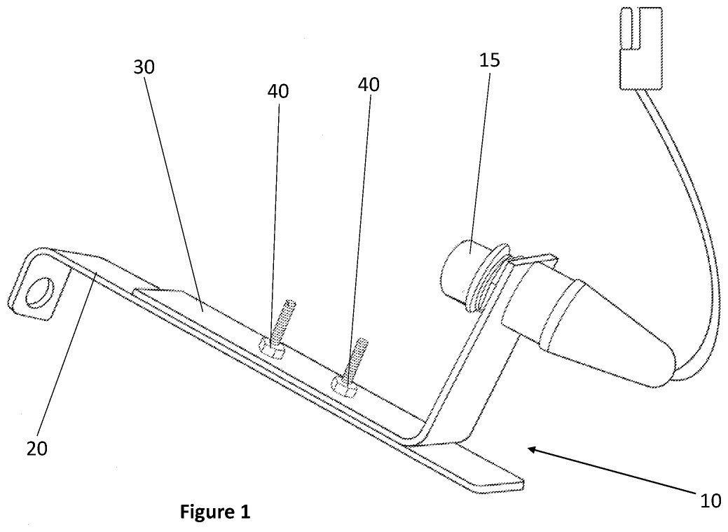

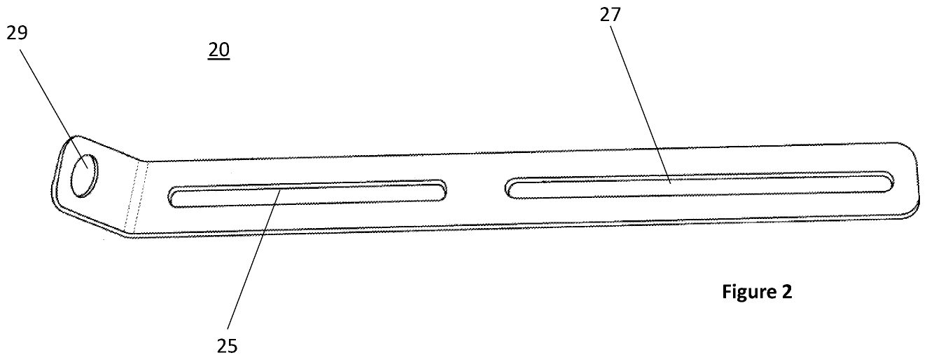

With reference to FIGS. 1, 2 and 3 and according to an embodiment of the present disclosure, a brake stroke indicator attachment 10 is shown to be secured to a vehicle. The attachment 10 is connected to a brake sensor 15, which sends a signal to a light (not shown) to alert the vehicle driver that the brakes need adjusting or are not as effective anymore. A worker skilled in the art would appreciate that such light would be installed on the front left outside corner of the trailer for a driver to see it from the mirror, or mounted on the dash inside the cab of the cab of the truck. The attachment 10 is preferably comprised of a first bracket 20, the first bracket 20 further comprised of two apertures 25, 27, shown as longitudinal slits as well as a second bracket 30, the second bracket 30 further comprised of an aperture 35, also shown as longitudinal slit. Although longitudinal slits are shown, a worker skilled in the art would appreciate that drilled holes could also be used. The first bracket 20 is further comprised of a first opening 29 and the second bracket 30 is further comprised of a second opening 37. The first opening 29 of the first bracket 20 is constructed and arranged to be secured to a brake chamber stud (not shown), typically by means of a bolt and a nut. To secure the first bracket 20 to the second bracket 30, securing mechanism 40, such as nuts and bolts, are inserted into the longitudinal slits 25, 27 of the first bracket 20 and through the longitudinal slits 35 of the second bracket 30. Before tightening the securing mechanism 40, the first bracket 20 can be adjusted relative to the second bracket 30 to provide a desired or optimal length. Once the first and second brackets 20, 30 are adjusted at the desired length for the attachment 10, the securing mechanism 40 is tightened such that the first and second brackets 20, 30 do not move one relative to the other.

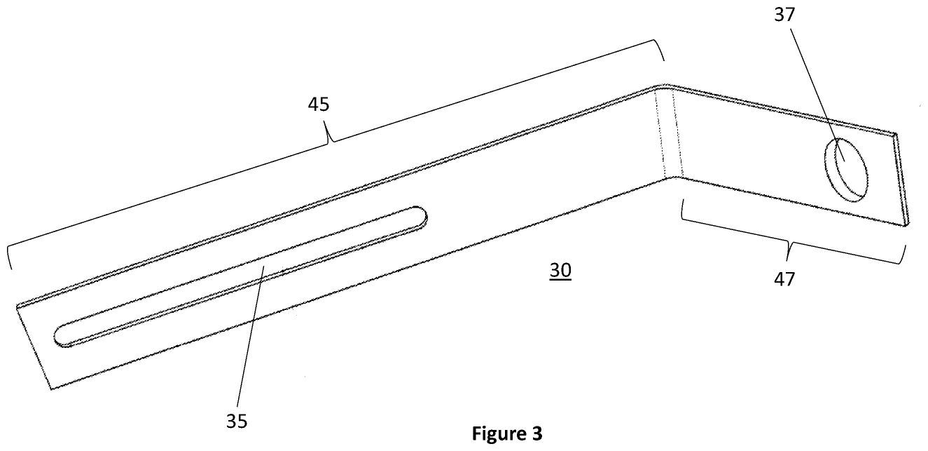

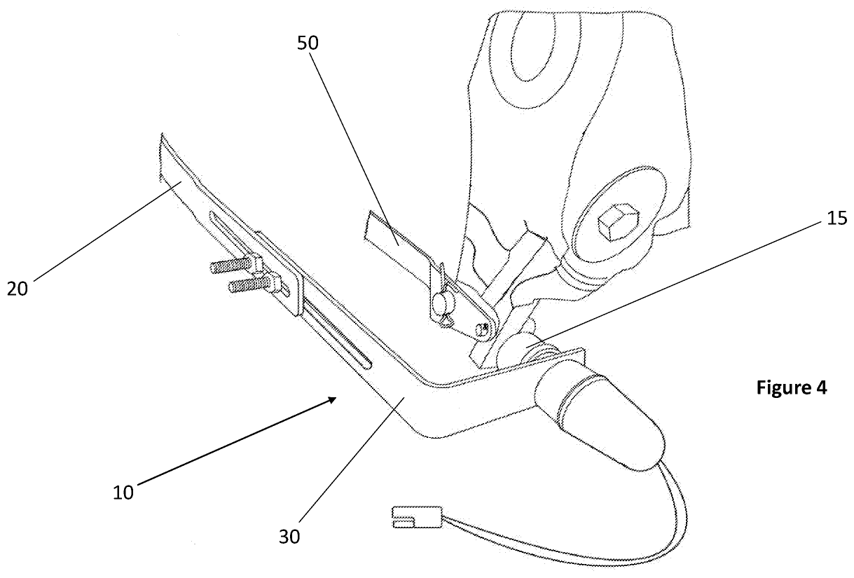

With reference to FIGS. 3 and 4 and according to an embodiment of the present disclosure, the second bracket 30 is further comprised of an elongated portion 45 and a stepped portion 47. The stepped portion 47 of the second bracket 30 is arranged so that it extends towards a slack adjuster 50 of the vehicle. The second opening 37 is positioned on the stepped portion 47 of the second bracket 30. The second opening 37 is able to receive and secure a sensor 15. The sensor 15 eventually comes into contact with the slack adjuster 50 as further detailed below. As is known, when a brake pedal is depressed for stopping, the slack adjuster 50 is pneumatically pushed back. As the brakes are used, the brake pads wear down and therefore the stroke measurement (the distance travelled by the slack adjuster 50) will increase. Eventually, the slack adjuster 50 will come into contact with the sensor 15, which will in turn complete a circuit. Completing said circuit will activate a light (not shown) to alert the driver of the vehicle that the brakes should be adjusted. Such adjustment could lead to a brake shoe replacement of other repairs o the braking components. An advantage of the present attachment 10 is that it is easy to install, inexpensive and utilizes existing power from the stop light circuit to power the light (not shown).

With further reference to FIG. 4, a method of securing the attachment 10 to a vehicle shall be described. First, the first bracket 20 is secured to the existing brake chamber stud. Then, the second bracket 30 is adjusted relative to the first bracket 20 at a distance X from the slack adjuster 50 The distance X depends on the optimal brake stroke measurement, which is calculated when the service brakes are fully applied. Indeed, in other words, upon installation, brakes are adjusted before full braking pressure is applied and the distance X is then measured. This distance X is then typically determined to be between ⅛ inch-¼ inch. The optimal brake stroke is measured to ensure that the attachment 10 is properly adjusted to be activated at the appropriate wear of the brakes. In standard applications, that has been determined to be ¾ of its legal travel limit. Once the distance X has been determined, the second bracket 30 is secured to the first bracket 20 so that the second bracket 30 does not move relative to the first bracket 20. Finally, a sensor 15 is attached into the second opening 37 of the second bracket 30.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A brake stroke indicator attachment for use with brakes comprising:
a first bracket secured to a vehicle, the first bracket further comprised of at least a first aperture; and,
a second bracket secured to the first bracket, the second bracket further comprised of:
an elongated portion further comprised of a second aperture; and,
a stepped portion further comprised of an opening,
wherein the opening of the second bracket is constructed and arranged to receive and secure a sensor thereto.

2. The brake stroke indicator of claim 1 wherein the first aperture is two longitudinal slits.

3. The brake stroke indicator of claim 1 wherein the second aperture is a longitudinal slit.

4. The brake stroke indicator of claim 1 wherein the first bracket is further comprised of a bent portion to be secured to the vehicle.

5. The brake stroke indicator of claim 1 wherein the first bracket is secured to the second bracket by a securing mechanism.

6. The brake stroke indicator of claim 5 wherein the securing mechanism is further comprised of a plurality of nuts and bolts.

7. The brake stroke indicator of claim 1 wherein the stepped portion is positioned at a distance X from a slack adjuster of the vehicle.

8. The brake stroke indicator of claim 7 wherein the distance X is a range between ⅛ inches and ¼ inches after full braking pressure is applied to the vehicle.

9. A method of installation of a brake stroke indicator attachment for use with brakes, the steps comprising:
securing a first bracket to a brake chamber stud; and,
adjusting a second bracket relative to the first bracket to a distance X from the slack adjuster,
wherein X is defined as ¾ of a brake stroke travel limit.

10. The method of claim 9 wherein X is a range between ⅛ inches and ¼ inches after full braking pressure is applied to the vehicle.

11. The method of claim 9 wherein a sensor is installed on the second bracket.

12. The method of claim 11 wherein the sensor is connected to a light to alert the driver of the vehicle that the brakes should be adjusted.

13. The method of claim 11 wherein the first bracket is secured to the second bracket by a securing mechanism.

14. The method of claim 13 wherein the securing mechanism is further comprised of a plurality of nuts and bolts.

15. The method of claim 9 wherein the first bracket is slid longitudinally relative to the second bracket.
